(19) United States
(12) Patent Application Publication
(10) Pub. No.: US 2015/0146209 A1
(43) Pub. Date: May 28, 2015

(54) USE OF BRAGG GRATINGS WITH COHERENT OTDR

(71) Applicants: Brooks A. Childers, Christiansburg, VA (US); Roger Glen Duncan, Christiansburg, VA (US)

(72) Inventors: Brooks A. Childers, Christiansburg, VA (US); Roger Glen Duncan, Christiansburg, VA (US)

(73) Assignee: BAKER HUGHES INCORPORATED, Houston, TX (US)

(21) Appl. No.: 14/525,341

(22) Filed: Oct. 28, 2014

Related U.S. Application Data
(60) Provisional application No. 61/907,465, filed on Nov. 22, 2013.

(51) Int. Cl. G01D 5/26; E21B 47/00

(52) U.S. Cl. CPC G01D 5/268; E21B 47/00
USPC 356/479

(57) ABSTRACT

An interferometer and a method of monitoring a downhole environment are described. The interferometer includes a coherent light source to emit pulses of light on a fiber, and a plurality of reflectors arranged on the fiber to reflect light from the coherent light source, each of the plurality of reflectors comprising broad band fiber Bragg gratings (FBGs), the fiber being rigidly disposed within a cable that is rigidly attached in the downhole environment. The interferometer also includes a processor to process a reflection signal resulting from the light reflected by two or more of the plurality of reflectors.

### CROSS-REFERENCE TO RELATED APPLICATION

This application claims the benefit of priority of U.S. Provisional Application No. 61/907,465 filed Nov. 22, 2013, the disclosure of which is incorporated by reference herein in its entirety.

### BACKGROUND

Many sensors and measurement tools are used in downhole exploration and production efforts. The tools provide information about the downhole environment and formations that are helpful in making a number of decisions. Some of these types of tools include pressure and temperature sensors, for example. Distributed acoustic sensor (DAS) systems are another of the types of tools used to obtain information about the downhole environment. DAS systems can provide information about strain, for example.

### SUMMARY

According to an aspect of the invention, an interferometer includes a coherent light source configured to emit pulses of light in a fiber; a plurality of reflectors arranged in the fiber and configured to reflect light from the coherent light source, each of the plurality of reflectors comprising broad band fiber Bragg gratings (FBGs), the fiber being rigidly disposed within a cable that is rigidly attached in the downhole environment; and a processor configured to process a reflection signal resulting from the light reflected by two or more of the plurality of reflectors.

According to another aspect, a method of monitoring a downhole environment includes disposing a fiber in the downhole environment, the fiber comprising a plurality of reflectors, each of the plurality of reflectors including broad band fiber Bragg gratings (FBGs) and the fiber being rigidly disposed in a cable that is ridigly attached in the downhole environment; emitting pulses of light from a coherent light source to illuminate the fiber; receiving a reflection signal based on the pulses of light from at least two of the plurality of reflectors; and processing the reflection signal using a processor to monitor the downhole environment.

### BRIEF DESCRIPTION OF THE DRAWINGS

Referring now to the drawings wherein like elements are numbered alike in the several Figures:

FIG. 1 is a cross-sectional illustration of a borehole and a distributed acoustic sensor system according to an embodiment of the invention;

FIG. 2 details the distributed acoustic system shown in FIG. 1; and

FIG. 3 is a process flow of a method of monitoring a downhole environment according to an embodiment of the invention.

### DETAILED DESCRIPTION

As noted above, distributed acoustic sensor (DAS) systems are among the types of sensors used in the downhole environment. Typically, DAS systems are based on Rayleigh backscatter signals. That is, a light source illuminates a fiber, and the resulting Rayleigh backscatter signals are processed. When an incoherent light source is used to illuminate the fiber, the resulting backscatter can serve to verify the installation of the DAS system, because loss at the connector and loss at the fiber link can be measured, for example. When a coherent light source is used instead, the result includes additional information about phase changes in the region being measured (the region where the reflectors of the DAS system are disposed). Embodiments of the system and method described below relate to optical time domain reflectometry (OTDR) using a coherent light source and also fiber Bragg gratings (FBGs) in the fiber so that phase changes in the reflection from the FBGs caused by various downhole parameter changes are readily discernible.

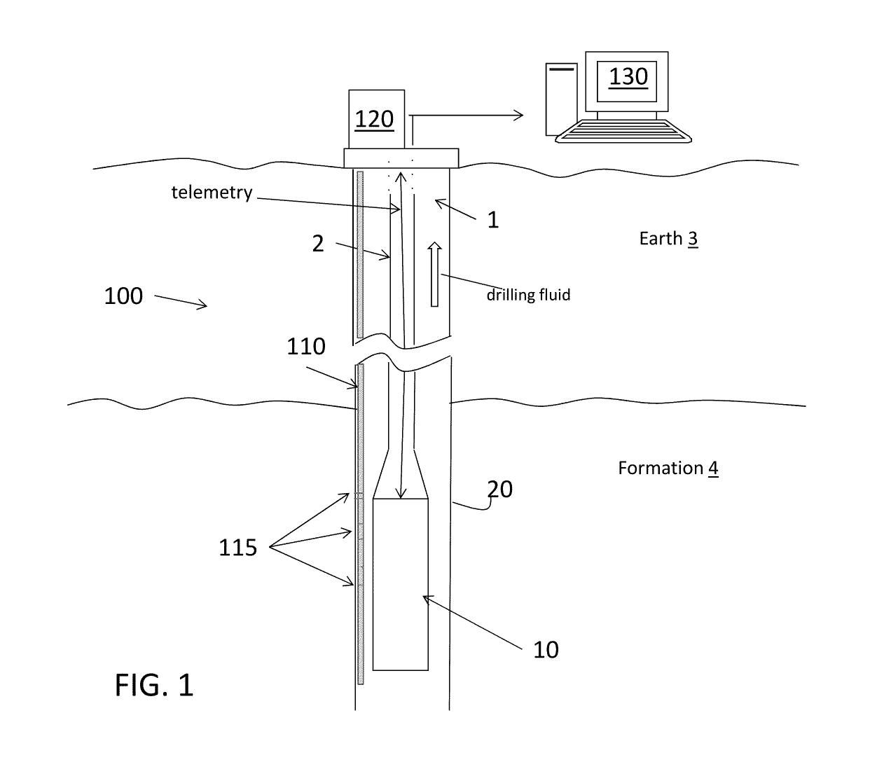

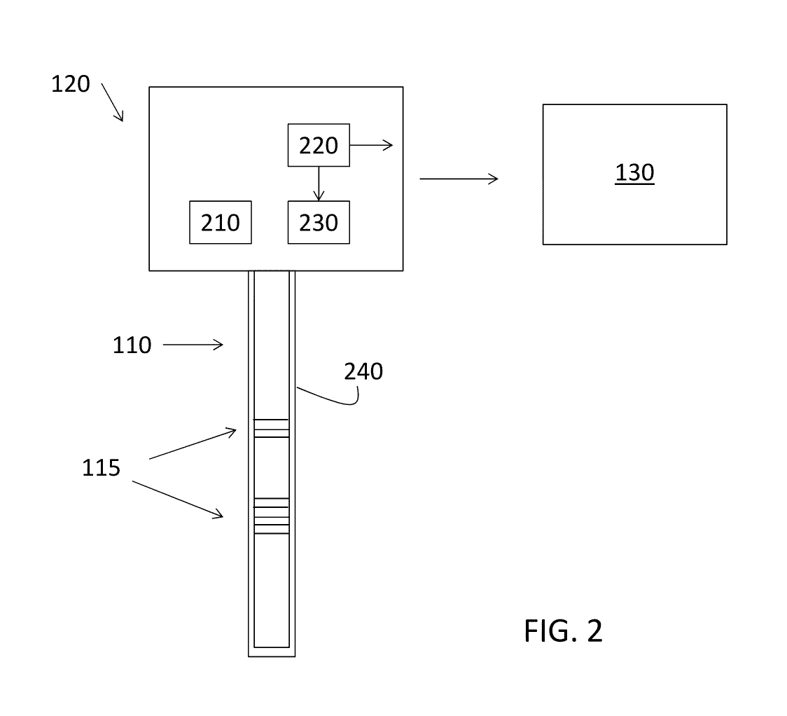

FIG. 1 is a cross-sectional illustration of a borehole 1 and a distributed acoustic sensor system 100 according to an embodiment of the invention. A borehole 1 penetrates the earth 3 including a formation 4. A set of tools 10 may be lowered into the borehole 1 by a string 2. Tubing or casing 20 may define and support the borehole 1. In embodiments of the invention, the string 2 may be a casing string, production string, an armored wireline, a slickline, coiled tubing, or a work string. In measure-while-drilling (MWD) embodiments, the string 2 may be a drill string, and a drill would be included below the tools 10. Information from the sensors and measurement devices included in the set of tools 10 may be sent to the surface for processing by the surface processing system 130 via a fiber link or telemetry. The surface processing system 130 (e.g., computing device) includes one or more processors and one or more memory devices in addition to an input interface and an output device. The distributed acoustic sensor system 100 includes an optical fiber 110 (the device under test, DUT). In the embodiment shown in FIG. 1, the optical fiber 110 includes fiber Bragg gratings (FBGs) 115. The distributed acoustic sensor system 100 also includes a surface interrogation unit 120 that includes a coherent light source 210 and one or more photodetectors 220, as discussed with reference to FIG. 2. Embodiments of the DAS 100 perform coherent optical time domain reflectometry (OTDR) using FBGs as described below.

FIG. 2 details the distributed acoustic system 100 shown in FIG. 1. In addition to the fiber 110 and the FBGs 115 (only 2 shown in FIG. 2), the surface interrogation unit 120 includes a coherent light source 210 and one or more photodetectors 220 to receive the reflected signal from the fiber 110. The surface interrogation unit 120 may additionally include a processing system 230 with one or more processors and memory devices to process the reflections. Alternately, the photodetectors 220 may output the reflection information to the surface processing system 130 for processing. The coherent light source 210 is one in which light waves are in phase with one another. The coherent light source 210 may be a laser, for example. In an exemplary embodiment, the coherent light source 210 emits pulses of light at the same wavelength and amplitude. The reflection of the pulses from each of the FBGs 115 interfere with each other (thus even two FGBs constitute an interferometer) and provide a reflected light signal to the photodetector 220. When the wavelength and amplitude of the pulses from the coherent light source 210 do not change, any change in the reflected light signal coming back to the photodetector 220 is attributable to a change in a downhole parameter (e.g., temperature, acoustics). In alternate embodiments, the wavelength or amplitude may change among the pulses that illuminate the fiber 110. In that case, the processing distinguishes changes in the reflected light signal caused by the change in the pulse amplitude or wavelength of the transmitted light with changes caused by changes in a downhole parameter. The distance between adjacent FBGs 115 is known in this case, for example, to aid in the processing.

The FBGs 115 may be manufactured using a draw tower process in which combines drawing the optical fiber 110 with writing the FBGs 115. While the FBGs 115 would have significantly higher reflectivity compared with backscatter, the FBGs 115 may be low reflectivity gratings (e.g., on the order of 0.001% reflectivity). The FBGs 115 may be broadband in order to minimize the chance that the wavelength of the coherent light source 210 output and the FBGs 115 do not match. In one embodiment, the optical fiber 110 with broadband FBGs 115 is ridigdly attached inside a cable 240. The cable 240 may be rigidly attached in the downhole environment (in the borehole 1) by being attached to a tubing or casing 20 (FIG. 1), for example. According to this embodiment, vibration and acoustic energy is efficiently coupled to the fiber. Employing the broad band FBGs 115 in this manner facilitates obtaining the reflections despite buildup of strain or temperature biases, for example.

According to one embodiment, the FBGs 115 may have a spacing among gratings such that a single pulse from the coherent light source 210 is enough to cover two or more FBGs 115 simultaneously. According to another embodiment the pulse length of the pulse from the coherent light source 210 may be smaller or the FBGs 115 may have larger spacing between gratings such that the reflections from two or more FBGs 115 do not interfere downhole. In this case, according to another embodiment, the surface interrogation unit 120 may include a surface interferometer that delays reflections based on one pulse with respect to another pulse in order to facilitate interference among reflections from the FBGs 115.

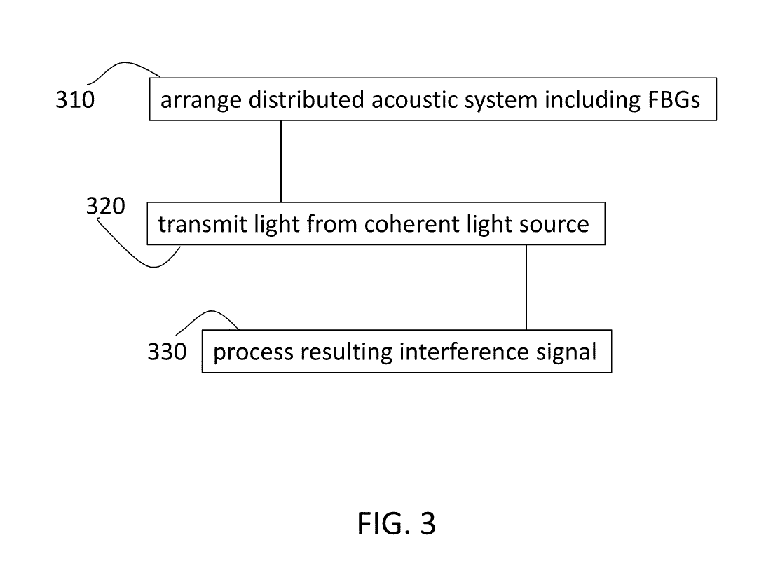

FIG. 3 is a process flow of a method of monitoring a downhole environment according to an embodiment of the invention. The method according to the embodiment uses a DAS 100 that implements coherent OTDR with FBGs 115. At block 310, arranging the DAS 100 including FBGs 115 includes disposing a fiber 110 downhole with FBGs 115, where the reflections from each pair of two adjacent FBGs are processed as one interferometer signal. This selective processing may be achieved through the selection of the pulse length and grating spacing. In alternate embodiments, more than two FBGs 115 may be part of an interferometer. The coherent light source 210 and photodetectors 220 in the surface interrogation unit 120 are also part of the DAS 100. At block 320, transmitting light from the coherent light source 210 to illuminate the fiber 110 results in each of the FBGs 115 providing a reflection. The reflection (interference of reflections) from two or more FBGs 115 may be received at a photodetector 220. Processing the interference signal at block 330 includes a processing system 230 of the surface interrogation unit 120 or the surface processing system 130 or another processor using the interference signal to determine a parameter or change in a parameter downhole.

For example, when the coherent light source 210 transmits pulses at the same wavelength and amplitude, the resulting interference signal would only change from pulse to pulse based on a change in a parameter (e.g., temperature, acoustics). Thus, each time the interference signal was unchanged, the processing of the interference signal would indicate that conditions downhole did not change in a way that affected the FBG 115 reflection (e.g., sound that has a pulling effect on the fiber 110, thereby increasing distance between the FBGs 115). When the interference signal does change, the parameter causing the change may be determined in a number of ways. Other sensors may be used in conjunction with the DAS 100 to isolate the cause or additional processing may be done to the interference signal to determine the change in FBGs 115 that resulted in the change in the interference signal.

While one or more embodiments have been shown and described, modifications and substitutions may be made thereto without departing from the spirit and scope of the invention. Accordingly, it is to be understood that the present invention has been described by way of illustrations and not limitation.

1. An interferometer, the interferometer comprising:
a coherent light source configured to emit pulses of light in a fiber;
a plurality of reflectors arranged in the fiber and configured to reflect light from the coherent light source, each of the plurality of reflectors comprising broad band fiber Bragg gratings (FBGs), the fiber being rigidly disposed within a cable that is rigidly attached in a downhole environment; and
a processor configured to process a reflection signal resulting from the light reflected by two or more of the plurality of reflectors.

2. The interferometer according to claim 1, wherein the reflection signal is an interference signal based on reflections from two or more of the plurality of reflectors.

3. The interferometer according to claim 2, further comprising an interferometer configured to output the reflection signal when the reflections from the two or more of the plurality of reflectors do not interfere based on a length of the pulses of light or a spacing among gratings of the FBGs.

4. The interferometer according to claim 1, wherein the coherent light source is a laser.

5. The interferometer according to claim 1, wherein the fiber is disposed in a downhole environment.

6. The interferometer according to claim 5, wherein the processor indicates whether one or more parameters in the downhole environment have changed based on the reflection signal.

7. The interferometer according to claim 1, wherein a wavelength and amplitude of each of the pulses of light is same.

8. The interferometer according to claim 7, wherein a change in the reflection signal resulting from a first pulse of light and resulting from a second pulse of light indicates a change in the downhole environment.

9. The interferometer according to claim 8, wherein the change in the downhole environment is a change of temperature, a change in acoustics, or a change in strain.

10. A method of monitoring a downhole environment, the method comprising:
disposing a fiber in the downhole environment, the fiber comprising a plurality of reflectors, each of the plurality of reflectors including broad band fiber Bragg gratings (FBGs) and the fiber being rigidly disposed in a cable that is ridigly attached in the downhole environment;
emitting pulses of light from a coherent light source to illuminate the fiber;
receiving a reflection signal based on the pulses of light from at least two of the plurality of reflectors; and
processing the reflection signal using a processor to monitor the downhole environment.

11. The method according to claim 10, wherein the receiving the reflection signal includes receiving an interference signal based on reflections from two or more of the plurality of reflectors.

12. The method according to claim 10, further comprising generating the reflection signal using a surface interferometer when reflections from two or more of the plurality of reflectors do not interfere based on a length of the pulses of light or a spacing among gratings of the FBGs.

13. The method according to claim 10, wherein the emitting light from the coherent light source includes emitting light from a laser.

14. The method according to claim 10, wherein the emitting the pulses of light includes maintaining a same wavelength and amplitude for each of the pulses of light.

15. The method according to claim 14, wherein when the processing indicates a change in the reflection signal resulting from a first pulse of light and resulting from a second pulse of light, the processing results in the processor determining a change in the downhole environment.

16. The method according to claim 15, wherein the determining the change in the downhole environment includes determining a change in temperature, a change in acoustics, or a change in strain.
